(19) United States
(12) Patent Application Publication
(10) Pub. No.: US 2009/0132361 A1
(43) Pub. Date: May 21, 2009

(54) CONSUMABLE ADVERTISING IN A VIRTUAL WORLD

(75) Inventors: Tobin R. Titus, Issaquah, WA (US); Ernest A. Booth, Bellevue, WA (US); Erik Porter, Kirkland, WA (US); Jeffrey D. Carnahan, New York, NY (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/943,610

(22) Filed: Nov. 21, 2007

(51) Int. Cl. G06Q 30/00

(52) U.S. Cl. 705/14

(57) ABSTRACT

Technologies are described herein for delivering advertising in a virtual world. A virtual object containing an advertisement is provided to an avatar. Whether the avatar has utilized the virtual object is determined. In response to determining that the avatar has utilized the virtual object, compensation is provided to a participant controlling the avatar.

### BACKGROUND

In recent years, massively multiplayer online (“MMO”) computer applications, such as massively multiplayer role-playing games (“MMORPGs”), have become extremely popular not only with serious gamers, but also with casual gamers and other Internet users. One example of a MMO computer application enables a participant to create and develop a fictional character in a virtual world. The fictional character is usually associated with an avatar or some other visual representation that enables other participants to recognize the particular fictional character. A given participant may develop, among other things, a storyline, a reputation, and attributes of her fictional character by interacting in the virtual world via the fictional character. Other examples of MMO computer applications may not involve the creation of a virtual world representation of the participant.

The virtual world typically includes an environment with a variety of virtual locations containing a variety of virtual objects. In some cases, the virtual locations and the virtual objects mimic realistic locations and objects, while in other cases, the virtual locations and virtual objects are fanciful creations. MMO computer applications generally permit the fictional character to travel across the virtual locations and interact with the virtual objects and other fictional characters.

Advertising in the modern age has proven to be increasingly challenging. In particular, conventional advertising techniques have become less effective especially in recent times. Consumers are now provided with substantially more entertainment options than just a few years ago, thereby reducing the number of consumers that are exposed to a given advertisement. Further, new technologies, such as portable music players, satellite radio, and digital video recorders (“DVRs”), have allowed the users to avoid or skip conventional advertisements entirely.

As advertisers try to find ways to reach more consumers, one advertising medium that has become more attractive are virtual worlds, like MMO computer applications. The number of participants in MMO computer applications has steadily increased in recent times, and this trend shows little, if any, signs of reversing. Further, MMO computer applications provide a single entertainment destination for many Internet users and gamers, thereby enabling advertisers to reach a larger number of consumers through a single advertising medium. As computer and Internet technologies continue to improve to provide more and better ways to include real-world advertisements within the virtual world, MMO computer applications will continue to grow as a significant advertising medium.

It is with respect to these considerations and others that the disclosure made herein is presented.

### SUMMARY

Technologies are described herein for delivering advertising in a virtual world. In particular, through the utilization of the technologies and concepts presented herein, an interface may be provided that enables an advertiser, for example, to provide participants with an interactive form of advertising in which an avatar controlled by a participant utilizes or otherwise consumes the virtual object containing the advertisement. Additionally, an advertisement may be provided in the virtual world in which the advertisement utilizes the avatar within the advertisement. The participant who controls the avatar may be compensated for utilizing the virtual object containing the advertisement or permitting the avatar to be utilized within an advertisement. In both of these cases, other participants or observers viewing the avatar may be exposed to the associated advertisement.

According to one aspect presented herein, a computer program is provided for delivering advertising in a virtual world. The computer program provides a virtual object containing an advertisement to an avatar in the virtual world. The computer program determines whether the avatar has utilized the virtual object. In one example, the avatar utilizes a clothing item by wearing the clothing item. In another example, the avatar utilizes a food item by ingesting the food item. In yet another example, the avatar utilizes a sporting good by playing with the sporting good. When the avatar utilizes the virtual object and interacts with other participants in the virtual world, other participants viewing the avatar are thereby exposed to the advertisement contained on the virtual object. Upon determining that the avatar has utilized the virtual object, the computer program provides compensation to the participant controlling the avatar. The computer program may also determine or modify a cost charged to the advertiser for providing the advertisement based on the exposure of the advertisement to other participants.

It should be appreciated that although the features presented herein are described in the context of a MMO computer application, these features may be utilized with any type of virtual world or environment including, but not limited to, other types of games as well as online social communities. It should also be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network architecture diagram showing aspects of a network architecture capable of implementing a virtual world;

FIG. 2 is a screen display diagram showing an illustrative screenshot of the virtual world in which an avatar utilizes a number of virtual objects containing advertisements, in accordance with one embodiment;

FIG. 3 is a screen display diagram showing another illustrative screenshot of the virtual world in which an advertisement utilizes the avatar within the advertisement, in accordance with one embodiment;

FIG. 4 is a flow diagram showing an illustrative process for delivering advertising in a virtual world, in accordance with one embodiment;

FIG. 5 is a flow diagram showing another illustrative process for delivering advertising in a virtual world; and

FIG. 6 is a computer architecture diagram showing aspects of an illustrative computer hardware architecture for a computing system capable of implementing the embodiments presented herein.

### DETAILED DESCRIPTION

The following detailed description is directed to technologies for delivering advertising in a virtual world. Through the utilization of the technologies and concepts presented herein, an avatar may be provided with a virtual object containing an advertisement. The virtual object may be utilized or otherwise consumed by the avatar. Additionally, an advertisement may be provided within the virtual world that utilizes the avatar within the advertisement. In this case, the avatar may be used to promote the advertisement by appearing within the advertisement.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

As used herein, the term virtual world refers to a computer-implemented environment, which may include simulated, lifelike environments as well as fanciful, non-existing environments. Exemplary virtual worlds may include any massively multiplayer online (“MMO”) computer application including, but not limited to, massively multiplayer online role-playing games (“MMORPGs”), virtual social communities, online video games, and virtual reality computer applications. In one embodiment, the MMO computer application simulates a real world environment. For example, the virtual world may be defined by a number of rules, such as the presence of gravity or the lack thereof. In other embodiments, the MMO computer application includes a fanciful environment that does not simulate a real world environment.

The virtual world is generally inhabited by avatars, which are virtual or symbolic representations of real world participants (hereinafter referred to as participants). As such, each avatar is typically associated with and controlled by a particular participant. Avatars may include two-dimensional and/or three-dimensional images. Through the virtual world, the avatars may interact with other avatars, as well as with virtual objects. Virtual objects may include virtual representations of real world objects, such as houses, cars, billboards, clothes, and soda cans, as well as fanciful creations, such as a teleportation machine or a flying car. According to exemplary embodiments, one or more virtual objects and one or more avatars in the virtual world are capable of providing an advertisement. The avatars and the virtual objects utilized in the virtual world may or may not be animated images.

As used herein, the term consumable advertising refers to any type of advertising that is applied, utilized, or otherwise consumed by a participant. By consuming the advertising, the participant may receive some benefit. In one example, an avatar may be seen in the virtual world drinking from a particular brand of soda can. After the contents in the soda can are consumed, the soda can is discarded or otherwise removed (i.e., becomes unavailable) from the virtual world. In this case, the soda may be consumed by the avatar to enter a promotion or contest, for example. In another example, an avatar may be seen wearing a clothing item, such as a t-shirt, that displays a particular advertisement. In this case, the advertiser may provide the avatar access to the t-shirt for only a short time. To encourage the avatar to wear the t-shirt, the advertiser may also provide compensation for wearing the t-shirt.

As used herein, the term consumable advertising also refers to advertising that utilizes an avatar to promote or sponsor the advertising. For example, during a soccer match or other sporting event in the virtual world, the avatar may score a critical goal or some other significant action. A large video screen owned by a particular advertiser may be included in the stadium hosting the soccer game. After the avatar scores the critical goal, the large video screen may display highlights (e.g., a replay) showing the critical goal. In this case, the featured avatar may be compensated for the amount of time in which the avatar was shown on the large video screen or compensated for the critical goal. The level of compensation may be based on any suitable factors. In one example, the amount of time in which the avatar is shown on the large video screen may determine the level of compensation. In another example, the type of highlight that is shown on the large video screen may also determine the level of compensation.

As previously mentioned, the avatar may be compensated for either displaying the advertising or allowing the advertising to display the avatar. Examples of compensation include, but are not limited to, real world currency, virtual world currency, real world objects, and virtual world objects. Another example of compensation is an avatar enhancement. For example, after the critical goal is shown on the large video screen, the avatar may be provided with enhanced skills (e.g., running faster, jumping higher) or other fanciful attributes (e.g., a colorful glow, or footprints in the shape of the advertiser's logo), for a limited period of time. In this way, the avatar is rewarded for being shown on the advertiser's video screen.

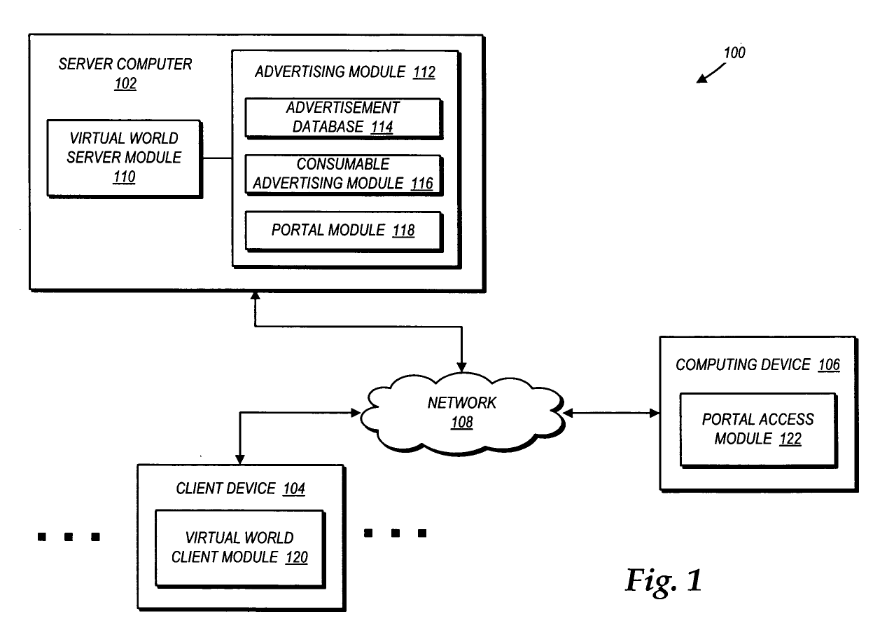

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for providing advertising in a virtual world will be described. In particular, FIG. 1 illustrates a simplified network architecture 100 for a virtual world. The network architecture 100 shown in FIG. 1 includes a server computer 102, a client device 104, and a computing device 106, all of which are operatively coupled via a network 108. The network 108 may be any suitable network, such as a local area network (“LAN”) or the Internet. Although only one client device 104 and one computing device 106 are illustrated in FIG. 1, the network architecture 100 may include multiple client devices and multiple computing devices in any suitable network configuration.

The client device 104 may be any suitable processor-based device, such as a computer or a gaming device. Exemplary gaming devices include the XBOX and the XBOX 360 from MICROSOFT CORPORATION, the WII from NINTENDO COMPANY, LIMITED, and the PLAYSTATION 3 and the PSP from SONY CORPORATION. Although not so illustrated in FIG. 1, the client device 104 may be coupled to any suitable peripheral devices to enable the participant to experience and interact with the virtual world. Exemplary peripheral devices may include an input device, such as a keyboard, a mouse, a microphone, and a game controller, and an output device, such as a display and speakers. Some peripheral devices may even provide both input and output functionality. For example, a game controller may provide vibration feedback.

As shown in FIG. 1, the client device 104 includes a virtual world client module 120, which interacts with the virtual world server module 110 executing on the server computer 102. In particular, the virtual world client module 120 may receive and process data from virtual world server module 110 and output the data to output devices coupled to the client device 104. Further, the virtual world client module 120 may receive data from input devices coupled to the client device 104 and transmit the data to the virtual world server module 110.

The virtual world client module 120 may include any suitable component for accessing the virtual world server module 110. In one example, the virtual world client module 120 may be a computer application configured to locally provide at least a portion of the virtual world for the client device 104. In this way, the amount of data retrieved from the server computer 102 by the client device 104 to generate the virtual world may be reduced. In another example, the virtual world client module 120 may be a web browser configured to retrieve the virtual world from the virtual world server module 110. Since many public computers, such as those found in Internet cafes, commonly have a web browser installed and prohibit the installation of new computer applications, providing participants a way to access the virtual world via the web browser may provide greater accessibility and convenience.

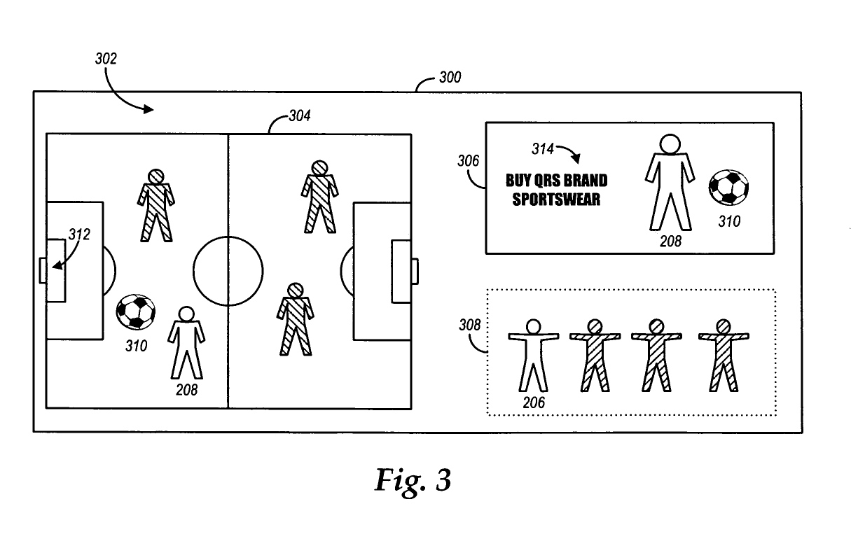

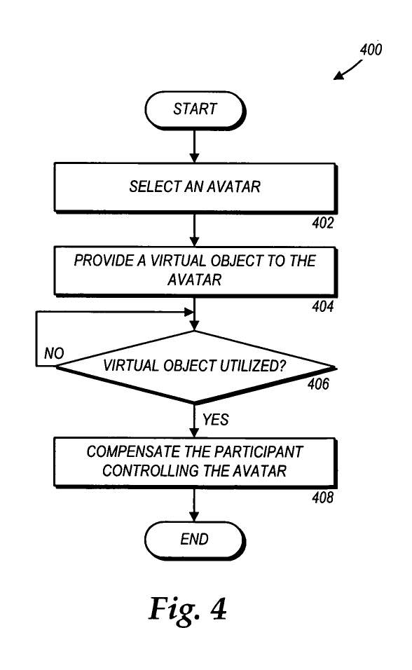

As shown in FIG. 1, the server computer 102 includes a virtual world server module 110 and an advertising module 112. The virtual world server module 110 generally administers the virtual world and serves as a conduit between multiple client devices, including the client device 104. The advertising module 112 generally enables an advertiser or other user to distribute advertising within the virtual world. The advertising module 112 may include an advertisement database 114, a consumable advertising module 116, and a portal module 118, as illustrated in FIG. 1. The advertisement database 114 may store one or more advertisements. The advertisement database 114 may include advertisements uploaded by an advertiser, for example. As described in greater detail below with respect to FIG. 3, the consumable advertising module 116 may identify avatars that can utilize a virtual object containing a consumable advertisement. As described in greater detail below with respect to FIG. 4, the consumable advertising module 116 may further identify avatars that can be displayed within a consumable advertisement in the virtual world.

An advertiser or other user may access the advertisement database 114 via the portal module 118. In one embodiment, the portal module 118 provides a website or other remote interface that enables an advertiser to access the advertisement database 114 via the network 108. In particular, the advertiser may utilize the computing device 106 to access the portal module 118. The computing device may include a portal access module 122 that enables communication with the portal module 118 via the network 108, as illustrated in FIG. 1. In one embodiment, the portal access module 122 is a web browser. The portal module 118 may enable an advertiser or other user to upload advertisements into the advertisement database 114. The advertisements may be in any suitable format including, but not limited to, text, audio, pictures, video, and combinations thereof. The portal module 118 may provide the advertiser or other user with a number of other options, such as an option to choose which avatars to select or target, how often avatars are selected or targeted, and the amount and type of compensation provided to the participants. Selection or targeting may be performed by specifying matching criteria such as the location of the participant, relevant demographics, the popularity of the participant with respect to other participants in the virtual world, and relevant game attributes (e.g., the avatar is in a soccer stadium, the avatar has reached a threshold level within a game).

When a participant desires to access the virtual world, the participant may initiate the virtual world client module 120 to establish a session with the virtual world server module 110 via the network 108. During the session, the virtual world server module 110 may transmit data (e.g., environment layouts, avatar movements of other participants) associated with the virtual world to the virtual world client module 120. Similarly, the virtual world client module 120 may transmit data from associated input devices to the virtual world server module 110. The virtual world client module 120 may further interact with the advertising module 112 to provide advertisements in the virtual world. Alternatively, the virtual world server module 110 may act as a conduit between the virtual world client module 120 and the advertising module 112 such that virtual world client module 120 and the advertising module 112 need not directly communicate.

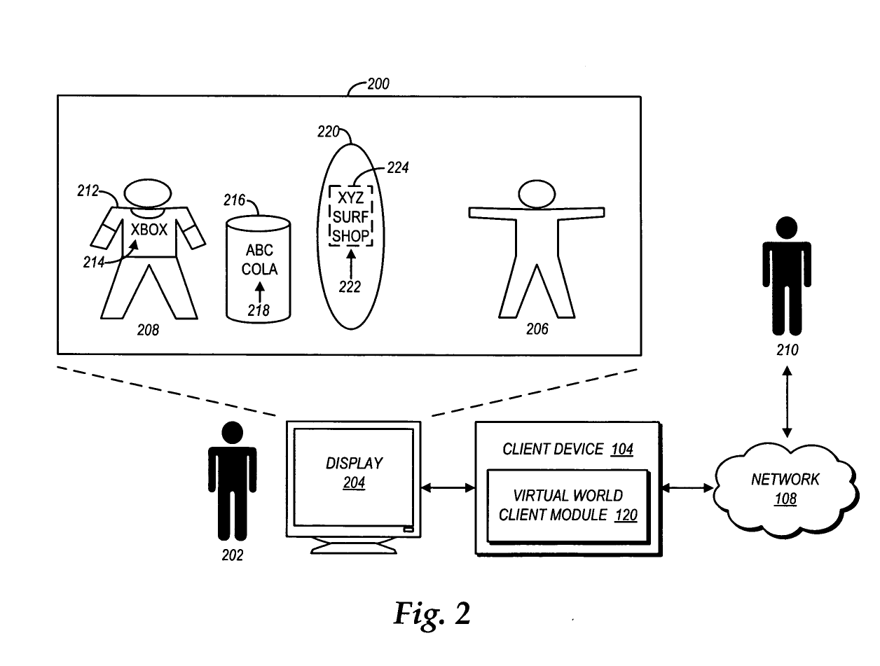

Turning now to FIG. 2, an illustrative screenshot 200 of the virtual world provided by the virtual world server module 110 and the virtual world client module 120 is shown, in accordance with one embodiment. The first participant 202 may view the screenshot 200 on a display 204 operatively coupled to the client device 104. The screenshot 200 illustrates a situation in which an advertiser distributes advertisements within the virtual world by allowing or enabling an avatar to utilize virtual objects containing the advertisements. Any participants who view the avatar utilizing those virtual objects or view the avatar after utilizing the virtual objects may thereby be exposed to the advertisements.

As shown in FIG. 2, the screenshot 200 includes a first avatar 206 and a second avatar 208. The first avatar 206 is a fictional representation of the first participant 202 in the virtual world. In one embodiment, the first participant 202 controls the movement of the first avatar 206 within the virtual world via an input device (not shown), such a keyboard, mouse, and game controller, operatively coupled to the client device 104. The first participant 202 may utilize the first avatar 206 to interact with other avatars, such as a second avatar 208, in the virtual world. In another embodiment, the first participant 202 may be a non-active observer of the virtual world. In this case, the first participant 202 may not control the first avatar 206, and interaction with the virtual world may be limited. The second avatar 208 may be the fictional representation of a second participant 210 associated with a second client device (not shown) at a remote location.

As illustrated in the screenshot 200, the second avatar 208 is wearing a t-shirt 212 that displays a first advertisement 214 for XBOX from Microsoft Corporation. The second avatar 208 is also associated with a soda can 216, which displays a second advertisement 218 for ABC brand cola, and a surfboard 220, which displays a third advertisement 222 for XYZ brand surf shop. In one embodiment, all three of the advertisements 214, 218, 222 are consumable advertisements. In one example, the t-shirt 212 may be a promotional item that is available to the second avatar 208 for a limited time. In another example, after the second avatar 208 consumes the contents of the soda can 216, the second avatar 208 may no longer have access to the contents of the soda can 216. In order to consume more contents, the second avatar 208 may acquire another soda can. In yet another example, the third advertisement 222 for XYZ surf shop is included in a sticker 224 that may be placed on the surfboard 220 for a limited time.

The advertisement may be tied to a virtual object that an avatar possesses for a limited time, or the advertisement itself may be placed for a limited time on a virtual object. The soda can 216 is an example of the advertisement being tied to the virtual object. Here, the second advertisement 218 is directly printed on the soda can 216 to indicate ABC brand cola, and the advertisement for ABC brand cola cannot be removed from the soda can 216. After consuming the contents of the soda can 216, the second avatar 208 may not be able to consume the contents again. In contrast to the soda can 216, the surfboard 220 is an example of the advertisement itself being placed for a limited time on the virtual object. Here, the third advertisement 222 is printed on a sticker 224 instead of directly on the surfboard 220. As such, while possession of the sticker 224 may be for a limited time, the second avatar 208 can still maintain possession of the surfboard 220 since the third advertisement 222 is not tied to the surfboard 220. Similar temporary advertisements may also be used other virtual objects, such as racing cars.

As illustrated in FIG. 2, the first avatar 206 has moved near the second avatar 208. The first participant 202 can generally view the surroundings of the first avatar 206, as illustrated in the screenshot 200. As such, the first participant 202 can view the second avatar 208 and any virtual objects that the second avatar 208 may be utilizing. In one example, the first participant 202 may view the second avatar 208 wearing the t-shirt 212, thereby exposing the first participant 202 to the first advertisement 214. In another example, the first participant 202 may view the second avatar 208 consuming the contents in the soda can 216, thereby exposing the first participant 202 to the second advertisement 218. In yet another example, the first participant 202 may view the second avatar 208 carrying or surfing on the surfboard 220, thereby exposing the first participant 202 to the third advertisement 222.

To encourage the second avatar 208 to utilize a virtual object containing an advertisement, the second avatar 208 and/or the second participant 210 may receive compensation for utilizing the virtual object. Compensation may include real world currency, virtual world currency, real world objects, and virtual objects. Compensation may also include enhancements of the second avatar 208. The amount or type of compensation may depend on various properties or number of participants exposed to the advertisement. For example, when the second avatar 208 utilizes a virtual object containing an advertisement, the second avatar 208 may grow bigger. In one embodiment, compensation is related to the amount of influence the second participant 210 has on other participants in the virtual world. In another embodiment compensation is related to the number of participants that view the act or result of consumption. After utilizing the virtual object, the virtual object may become unavailable. In this case, to receive additional compensation, the second avatar 208 may acquire additional virtual objects to be utilized.

Turning now to FIG. 3, another illustrative screenshot 300 of the virtual world provided by the virtual world server module 110 and the virtual world client module 120 is shown, in accordance with one embodiment. The first participant 202 may view the screenshot 300 on a display 204 operatively coupled to the client device 104. In contrast to FIG. 2, the screenshot 300 illustrates a situation in which an advertisement displays an avatar within the advertisement. As shown in FIG. 3, the screenshot 300 illustrates a soccer stadium 302, which includes a soccer field 304, a large video screen 306, and a spectator area 308. The soccer stadium 302 includes a number of soccer players, including the second avatar 208, playing a soccer match. The spectator area 308 includes a number of spectators, including the first avatar 206, watching the soccer match and the video screen 306.

In one embodiment, the video screen 306 shows highlight plays of the soccer match. For example, the second avatar 208 may kick a soccer ball 310 into a soccer goal 312 to score a point. During or after the second avatar 208 scores the point, the video screen 306 may show the second avatar 208 kicking the soccer ball 310 along with an advertisement 314. As the first avatar 206 views the video screen 306, the first avatar 206 is exposed to the advertisement 314.

Although the video screen 306 shows the soccer match from a third person perspective, it should be appreciated that the soccer match may also be shown in a first person perspective of the second avatar 208 or from other angles. Thus, if the second avatar 208 kicks the soccer ball 310 to score a goal, the video screen 306 may show a video highlight (i.e., replay) of the second avatar 208 kicking the goal. To encourage participants, the advertiser may compensate those utilized in the advertisement. As previously mentioned, compensation may include real world currency, virtual world currency, real world objects, and virtual objects. Compensation may also include enhancements of the second avatar 208. For example, when the second avatar 208 is shown on the video screen 306, the second avatar 208 may acquire a special glow or other visual effect for a limited time.

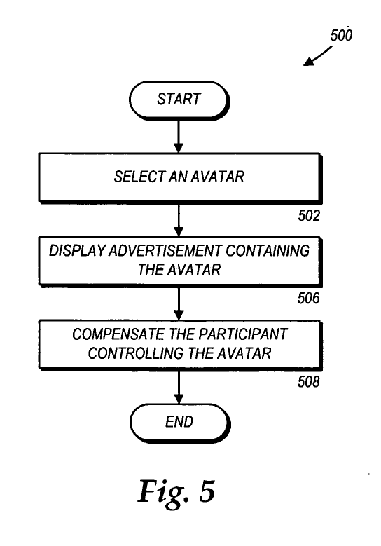

Referring now to FIGS. 4 and 5, additional details will be provided regarding utilization of an avatar to deliver advertising in a virtual world. In particular, FIG. 4 is a flow diagram illustrating aspects of one method provided herein for utilizing an avatar to deliver an advertisement in a virtual world by way of a virtual object containing the advertisement. FIG. 5 is a flow diagram illustrating aspects of one method provided herein for incorporating a likeness or a perspective of an avatar within an advertisement in the virtual world. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

Referring to FIG. 4, a routine 400 begins at operation 402, where the consumable advertising module 116 selects or targets an avatar in the virtual world. In one embodiment, the avatar is selected to deliver an advertisement by way of a virtual object containing the advertisement. To this end, the avatar selected may be a popular avatar that is viewed by a large number of participants of the virtual world. If more participants view the avatar while the avatar utilizes the virtual object containing the advertisement, then more participants will be exposed to the advertisement. The avatar may also be selected or targeted by any other suitable criteria, such as demographic criteria (e.g., avatars living in New York) and gameplay criteria (e.g., avatars present in a soccer stadium), as contemplated by those skilled in the art. In one example, the consumable advertising module 116 selects the second avatar 208. After the consumable advertising module 116 selects the second avatar 208, the routine 400 continues to operation 404.

At operation 404, the consumable advertising module 116 provides an advertisement to the second avatar 208. In one embodiment, an advertiser or other user accesses the portal module 118 via the portal access module 122 in the computing device 106 to upload advertisements into the advertisement database 114 and to select which advertisements for the consumable advertising module 116 to distribute the user may also specify the type or amount of compensation associated with the consumption of this advertisement. In one example, the consumable advertising module 116 provides the t-shirt 212 containing the first advertisement 214 to the second avatar 208. In another example, the consumable advertising module 116 provides the sticker 224 containing the third advertisement 222 to the second avatar 208. The second avatar 208 may then place the sticker 224 on the surfboard 220.

Although not so limited, operations 402 and 404 describe an exemplary process by which the consumable advertising module 116 selects an avatar and provides a virtual object containing an advertisement to the selected avatar. In other embodiments, the avatar may not be selected by the consumable advertising module 116 to receive the virtual object. In one example, the second avatar 208 may purchase the soda can 216 containing the second advertisement 218 in a virtual soda machine (not shown) in the virtual world. In another example, the second avatar 208 may win the t-shirt 212 in a contest organized by an advertiser. In yet another example, the second avatar 208 may find the sticker 224 in a scavenger hunt organized by an advertiser. The second avatar 208 may then place the sticker 224 on the surfboard 220. After the consumable advertising module 116 provides the advertisement to the second avatar 208, the routine 400 continues to operation 406.

At operation 406, the consumable advertising module 116 determines whether the second avatar 208 has utilized the virtual object. In one example, the second avatar 208 may utilize the t-shirt 212 by wearing the t-shirt 212 for a given amount of time. In another example, the second avatar 208 may utilize the soda can 216 by consuming the contents in the soda can 216. In yet another example, the second avatar 208 may utilize the sticker 224 by placing the sticker 224 on the surfboard 220 for a given amount of time. While the second avatar 208 utilizes the virtual object, other participants, such as the first participant 202, may view the second avatar 208 utilizing the virtual object. As such, these other participants may be exposed to the advertisement on the virtual object. After the second avatar 208 utilizes the virtual object, the routine 400 continues to operation 408.

At operation 408, the consumable advertising module 116 compensates the second avatar 208 for utilizing the virtual object. The compensation may encourage the second avatar 208 to utilize the virtual object. The compensation may include real world currency, virtual world currency, real world objects, and virtual objects. The compensation may also include enhancements of the avatar. For example, consuming the contents of the soda can 216 may cause the second avatar 208 to grow taller. The amount of compensation may be dependent on any suitable criteria including, but not limited to, the popularity of the second avatar 208, the actual number of participants viewing the advertisement on the virtual object, properties of the participants viewing the advertisement (e.g., a participant earning a threshold income, a participant that has previously consumed a competitor's product), and the estimated number of participants viewing the advertisement on the virtual object. After consuming the contents of the soda can 216 or otherwise utilizing the virtual object, the soda can 216 or virtual object may become unavailable. In this case, the second avatar 208 may acquire additional soda cans or virtual objects and consume the additional soda cans or virtual objects to receive additional compensation.

Referring now to FIG. 5, a routine 500 begins at operation 502, where the consumable advertising module 116 selects an avatar in the virtual world. In one embodiment, the avatar is selected to be included in an advertisement to be displayed in the virtual world. To this end, the avatar selected may be selected after performing a highlight in the virtual world. In one example, the consumable advertising module 116 may select the second avatar 208 after the second avatar 208 scores a crucial goal in a soccer match, as illustrated in FIG. 3. If more participants view the avatar while the avatar is included in an advertisement, then more participants will be exposed to the advertisement. The avatar may also be selected by any other suitable criteria as contemplated by those skilled in the art. After the consumable advertising module 116 selects the second avatar 208, the routine 500 continues to operation 506.

At operation 506, the consumable advertising module 116 may include the second avatar 208 in an advertisement. In one embodiment, the consumable advertising module 116 includes the second avatar 208 in an advertisement as a result of the second avatar 208 performing a significant action (e.g., a highlight). For example, the screenshot 300 illustrates an advertisement 314 for QRS BRAND SPORTSWEAR that includes the second avatar 208 as a result of the second avatar 208 scoring a goal in a soccer match. While the second avatar 208 is displayed in the advertisement 314, other participants, such as the first participant 202, may view the second avatar 208 and may be exposed to the advertisement 314. After the second avatar 208 is included in the advertisement 314, the routine 500 continues to operation 508.

At operation 508, the consumable advertising module 116 compensates the second avatar 208 for allowing the consumable advertising module 116 to include the second avatar 208 in the advertisement 314. The compensation may include real world currency, virtual world currency, real world objects, and virtual objects. The compensation may also include enhancements of the avatar. For example, during or after the second avatar 208 is shown on the video screen 306, the second avatar 208 may have a glowing or other visual effect while on the soccer field 304. The amount of compensation may be dependent on any suitable criteria including, but not limited to, the popularity of the second avatar 208, the actual number of participants viewing the advertisement including the second avatar 208, properties of the participants viewing the advertisement including the second avatar 208, and the estimated number of participants viewing the advertisement including the second avatar 208.

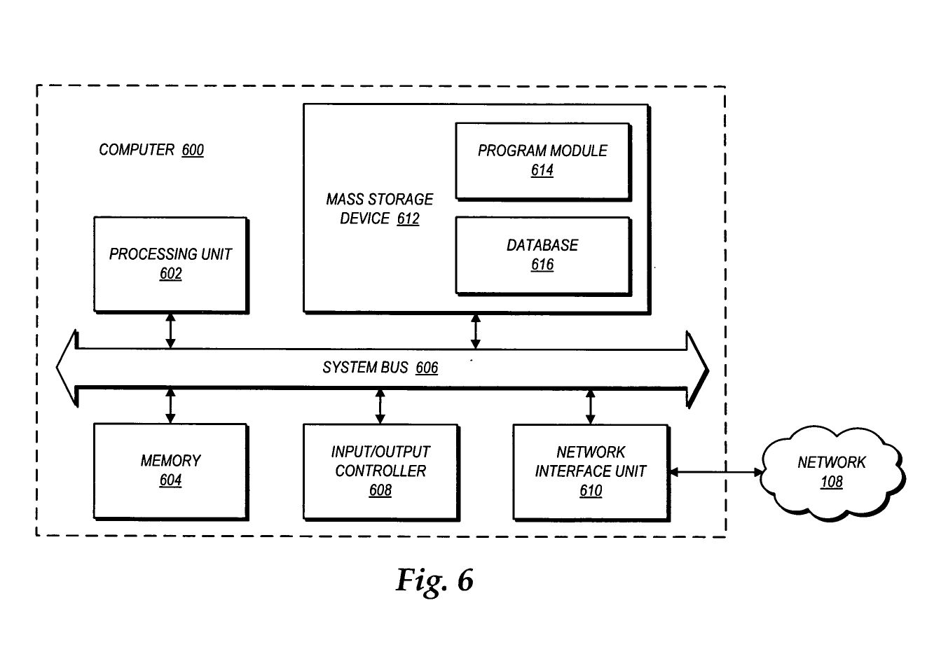

Referring now to FIG. 6, an exemplary computer architecture diagram showing aspects of a computer 600 is illustrated. Examples of the computer 600 may include the server computer 102, the client device 104, and the computing device 106. The computer 600 includes a processing unit 602 (“CPU”), a system memory 604, and a system bus 606 that couples the memory 604 to the CPU 602. The computer 600 further includes a mass storage device 612 for storing one or more program modules 614 and one or more databases 616. Examples of the program modules 614 may include the consumable advertising module 116, the portal module 118, the virtual world client module 120, and the portal access module 122. Examples of the databases 616 may include the advertisement database 114. The mass storage device 612 is connected to the CPU 602 through a mass storage controller (not shown) connected to the bus 606. The mass storage device 612 and its associated computer-readable media provide non-volatile storage for the computer 600. Although the description of computer-readable media contained herein refers to a mass storage device, such as a hard disk or CD-ROM drive, it should be appreciated by those skilled in the art that computer-readable media can be any available computer storage media that can be accessed by the computer 600.

By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network such as the network 108. The computer 600 may connect to the network 108 through a network interface unit 610 connected to the bus 606. It should be appreciated that the network interface unit 610 may also be utilized to connect to other types of networks and remote computer systems. The computer 600 may also include an input/output controller 608 for receiving and processing input from a number of input devices (not shown), including a keyboard, a mouse, a microphone, and a game controller. Similarly, the input/output controller 608 may provide output to a display or other type of output device (not shown).

Based on the foregoing, it should be appreciated that technologies for delivering consumable advertising in a virtual world are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for delivering advertising in a virtual world, the method comprising:
providing a virtual object containing an advertisement to an avatar;
determining whether the avatar has utilized the virtual object; and
in response to determining that the avatar has utilized the virtual object, providing compensation to a participant controlling the avatar.

2. The method of claim 1, further comprising selecting the avatar based on advertiser specified properties associated with the avatar.

3. The method of claim 1, wherein determining whether the avatar has utilized the virtual object comprises determining whether the avatar has worn the virtual object.

4. The method of claim 1, wherein determining whether the avatar has utilized the virtual object comprises determining whether the avatar has consumed a content of the virtual object.

5. The method of claim 4, wherein the virtual object becomes unavailable after the avatar has consumed the content of the virtual object.

6. The method of claim 1, wherein determining whether the avatar has utilized the virtual object comprises determining whether the avatar has attached the virtual object on another virtual object.

7. The method of claim 1, wherein providing compensation comprises providing one or more of real world currency, virtual world currency, a real world object, and a virtual world object.

8. The method of claim 1, wherein providing compensation comprises enhancing an attribute of the avatar.

9. The method of claim 1, wherein providing a virtual object containing an advertisement to an avatar comprises providing the virtual object containing the advertisement to the avatar in response to the participant winning a contest.

10. The method of claim 1, wherein providing a virtual object containing an advertisement to an avatar comprises providing the virtual object containing the advertisement to the avatar in response to the participant purchasing the virtual object.

11. The method of claim 1, wherein providing a virtual object containing an advertisement to an avatar comprises providing the virtual object containing the advertisement to the avatar in response to the participant finding the virtual object in the virtual world.

12. A method for delivering advertising in a virtual world, the method comprising:
selecting a participant controlled avatar;
displaying an advertisement containing the avatar in the virtual world; and
providing compensation for displaying the advertisement containing the avatar in the virtual world.

13. The method of claim 12, wherein selecting a participant controlled avatar comprises selecting the avatar that has performed a significant action in the virtual world.

14. The method of claim 13, wherein the significant action comprises an action from a sporting event.

15. The method of claim 13, wherein displaying an advertisement containing the avatar in the virtual world comprises displaying a replay of the avatar performing the significant action in the virtual world.

16. The method of claim 12, wherein providing compensation comprises enhancing an attribute of the avatar.

17. The method of claim 16, wherein enhancing the attribute of the avatar comprises acquiring a visual effect for a limited time.

18. The method of claim 12, wherein selecting a participant controlled avatar comprises selecting the participant controlled avatar based on one or more of a demographic criterion associated with the participant, a popularity of the participant, or an attribute of the virtual world.

19. A computer-readable medium having computer-executable instructions stored thereon which, when executed by a computer, cause the computer to:
determine whether a participant controlled avatar has performed a highlight in a virtual world;
in response to determining that the avatar has performed the highlight in the virtual world, insert the avatar into an advertisement;
display the advertisement in the virtual world; and
enhance an attribute of the avatar as compensation for inserting the avatar into the advertisement.

20. The computer-readable medium of claim 19 having further computer-executable instructions stored thereon which, when executed by a computer, cause the computer to determine an amount to enhance the attribute of the avatar based on a one or more of number of participants exposed to the displayed advertisement or properties of the participants exposed to the displayed advertisement.
